(19) United States
(12) Patent Application Publication
(10) Pub. No.: US 2007/0279842 A1
(43) Pub. Date: Dec. 6, 2007

(54) ELECTRICAL CONNECTION BOX

(75) Inventors: Yuichi ISHIDA, Kakegawa-shi (JP); Masaaki ISHIGURO, Kakegawa-shi (JP); Kazuaki NAKAMURA, Kakegawa-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 11/755,020

(22) Filed: May 30, 2007

(30) Foreign Application Priority Data
May 30, 2006 (JP) P2006-149983

(51) Int. Cl. H02B 1/00

(52) U.S. Cl. 361/600

(57) ABSTRACT

An electrical connection box includes a circuit substrate on which an electrical component is mounted, a case which is adapted to cover the circuit substrate, and a heat radiation member which is directly attached to the electrical component.

### BACKGROUND OF THE INVENTION

The present invention relates to an electrical connection box for housing a circuit substrate on which electrical circuits such as power supply circuits are mounted.

In general, circuit substrates including electrical circuits such as power supply circuits are installed in the vehicles with boxes receiving the circuit substrates. In this case, when the circuit substrate is a circuit substrate including a large-current electrical circuit such as a power supply circuit having a large calorific value, the radiation performance of the box should be enough large.

A related circuit substrate having a countermeasure for radiating the heat is shown in FIG. 7 In a related circuit substrate 4 in which a metal plate 3 is disposed on an insulation resin layer 1 with an insulation layer 2 interposed therebetween, a metal column 5 is buried in the insulation resin layer 1, and the metal column 5 is uprightly disposed on the insulation layer 2 with a conductor layer 6 interposed therebetween (for example, see JP-A-2003-179316). As a result, the heat of an electrical component 8 which is attached to the metal column 5 with an insulation layer 7 interposed therebetween is transmitted and radiated to the metal plate 3 via the metal column 5.

In the related circuit substrate, it is necessary to bury the metal column 5 in the insulation resin layer 1, so as to smoothly transmit the heat from the electrical component 8 through the metal column 5 to the metal plate 3. In such a structure in which the metal column 5 is buried in the insulation resin layer 1, the structure of the substrate is complicated and a great effort is required for manufacturing the structure, thereby causing the rise in cost.

In addition, when the metal column 5 is buried in the insulation resin layer 1, a great effort is required for detaching the metal column 5 at the time of dismantling the structure.

Therefore, when such a circuit substrate is employed in the electrical connection box, the rise in manufacturing cost and the degradation in recycling property can be caused.

### SUMMARY

It is therefore an object of the invention to provide an electrical connection box having superior soaking and radiation performance and capable of reducing in size and weight.

In order to achieve the object, according to the invention, there is provided an electrical connection box, comprising:

a circuit substrate, on which an electrical component is mounted;

a case, adapted to cover the circuit substrate; and

a heat radiation member, directly attached to the electrical component.

### BRIEF DESCRIPTION OF THE DRAWINGS

FIG. 1 is an exploded perspective view illustrating the structure of an electrical connection box according to a first embodiment of the invention.

FIG. 2 is a perspective view illustrating a circuit substrate on which an electrical component is mounted.

FIG. 3 is a sectional view illustrating a mounting portion of the circuit substrate at which the electrical component is mounted on the circuit substrate.

FIG. 4 is an exploded perspective view illustrating the structure of an electrical connection box according to a second embodiment of the invention.

FIG. 5 is a perspective view illustrating the circuit substrate to which a heat radiation member is attached.

FIG. 6 is a sectional view illustrating an attaching portion of the circuit substrate at which the heat radiation member is attached to the electrical component.

FIG. 7 is a sectional view describing the structure of a related circuit substrate.

### DETAIL DESCRIPTION OF PREFERRED EMBODIMENTS

Hereinafter, an electrical connection box according to embodiments of the invention will be described in more detail with reference to drawings.

### First Embodiment

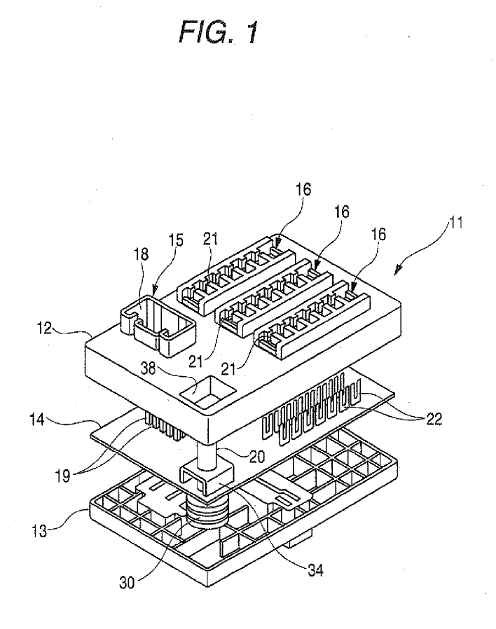

Now, the electrical connection box according to a first embodiment will be described in detail with reference to FIGS. 1 to 3.

As shown in FIG. 1, the electrical connection box 11 has an upper case (case) 12 and a lower case (case) 13. The circuit substrate 14 is disposed between the upper case 12 and the lower case 13. The circuit substrate 14 is covered with the upper case 12 and the lower case 13. A wiring pattern (not shown) is formed on both surfaces (front and back surfaces) of the circuit substrate 14. For example, the electrical components (not shown), such as fuses, electronic control units are mounted on the circuit substrate 14.

The upper case 12 and the lower case 13 are formed of, for example, polypropylene incorporating the glass fiber. The circuit substrate 14 is arranged between the upper case 12 and the lower case 13, and then in the state that the upper case 12 and the lower case 13 retain the circuit substrate 14 therebetween, the upper case 12 and the lower case 13 are assembled.

The electrical connection box 11 has a plurality of sockets 15 connectable with connectors of a wiring harness.

The socket 15 has an engaging concave portion 18 formed in the upper case 12. A connection terminal 19 is arranged within the engaging concave portion 18, which is uprightly formed so as to electrically connect to the wiring pattern of the circuit substrate 14. In addition, in the socket 15, the connector of the wiring harness is engaged with the engaging concave portion 18, and then a terminal of the connector is electrically connected to the connection terminal 19 of the socket 15.

Additionally, the electrical connection box 11 has a plurality of component-fixing sockets 16 capable of attaching the electrical component, such as an external relay.

Each of the component-fixing sockets 16 has an engaging concave portion 21 formed in the upper case 12. A connecting terminal 22 is arranged within the engaging concave portion 21, which is uprightly formed so as to electrically connect to the wiring pattern of the circuit substrate 14. In addition, in the component-fixing socket 16, the electrical component is engaged with the engaging concave portion 21, and then a connection terminal or the electrical component is electrically connected to the connection terminal 22 of the component-fixing socket 16.

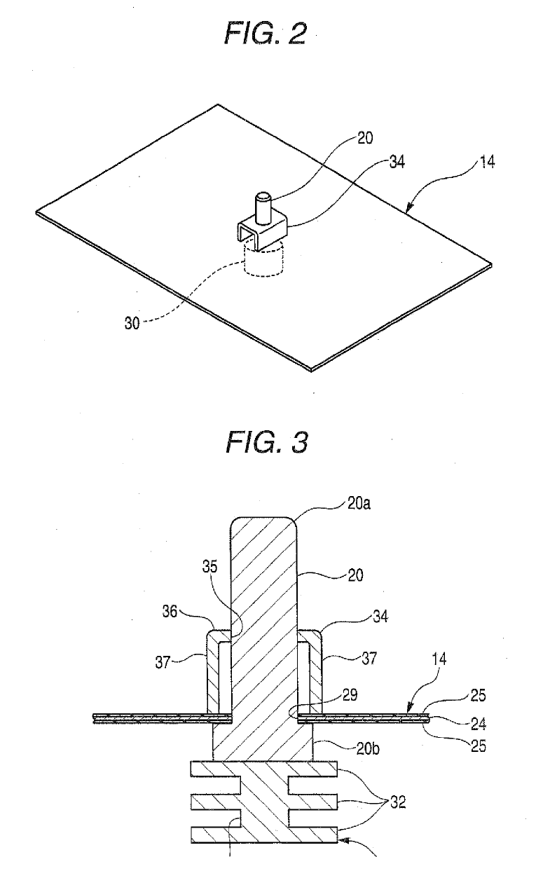

As shown in FIGS. 2 and 3, the electrical component 20 is inserted into a through-hole 29 that is formed in the circuit substrate 14. One end 20a and the other end 20b of the electrical component 20 are protruded from both sides of the circuit substrate 14, respectively.

A heat radiation member 30 is attached to the other end 20b of the electrical component 20. In the heat radiation member 30, a plurality of disk-shaped tins 32 are disposed in the periphery of a cylindrical support portion 31 with intervals (spaces). The heat radiation member 30 is integrally formed of a metallic material having superior heat conductivity such as copper or aluminum. The plurality of fins 32 are extended in a direction parallel to the circuit substrate 14 from the support portion 31.

In the electrical component 20, a supporting member 34 is attached to the front surface of the circuit substrate 14. The supporting member 34 has a holding plate portion 36 having a hole 35 through which the electrical component 20 can pass, and side plate portions 37 formed in both side surfaces of the holding plate portion 36. The electrical component 20 passes through the hole 35 of the holding plate portion 36 and then the side plate portions 37 are fixed to the circuit substrate 14, and thus one end 20a of the electrical component 20 is supported. As a result, the electrical component 20 is secured to the circuit substrate 14.

Additionally, a holding hole 38 is formed in the upper cover 12 for holding the electrical component 20. When the circuit substrate 14 is housed within the upper the cover 12 and the lower the cover 13, the electrical component 20 supported by the supporting member 34 is housed and then held in the holding hole 38 of the upper cover 12.

In addition, as shown in FIG. 3, the circuit substrate 14, which is formed of the metal core substrate, includes a plate-shaped metal core 24 and an insulation portion 25 covering the metal core 24. The circuit substrate 14 is an electrical circuit substrate in which the metal core 24 and the insulation portion 25 are multilayered.

The metal core 24 is, for example, a plate made of copper. The insulation portion 25 is made of any suitable material having nonconductive property and low heat conductivity, such as glass epoxy resin. In addition, instead of the copper, aluminum that specific gravity is about one third of copper may be employed as the material of the metal core 24.

On the circuit substrate 14 made of the metal core substrate, the conductive circuit pattern (not show) made of copper foil is formed in the insulation portion 25, and soldered to the terminal of the electrical component 20 to electrically connect therebetween.

In view of above, according to the electrical connection box regarding to the first embodiment, the heat radiation member 30 is directly attached to the electrical component 20. As a result, the heat of the electrical component 20 is effectively radiated to the heat radiation member 30, and also as compared to the related structure in which the metal column is buried in the substrate, the reduction in manufacturing cost and improvement of recycling property can be accomplished. Hence, without using the bus bar, large current is introduced to the circuit substrate 14, and therefore the simplification of structure and reduction in size and weight can be obtained.

In particular, since the metal core substrate is employed as the circuit substrate 14, the heat of the electrical component 20 is transmitted to the metal core 24 of the circuit substrate 14 and then effectively radiated therefrom.

Further, since a plurality of fins 32 are provided to the heat radiation member 30, the heat of the electrical component 20 is effectively radiated from the fins 32 of the heat radiation member 30.

In the aforementioned first embodiment, the case that the metal core substrate is employed as the circuit substrate 14 has been described as an example. However, since the sufficient heat radiation of the electrical component 20 using the heat radiation member 30 is performed, any general circuit substrate which is made of, for example, glass epoxy resin may be employed as the circuit substrate 14.

### Second Embodiment

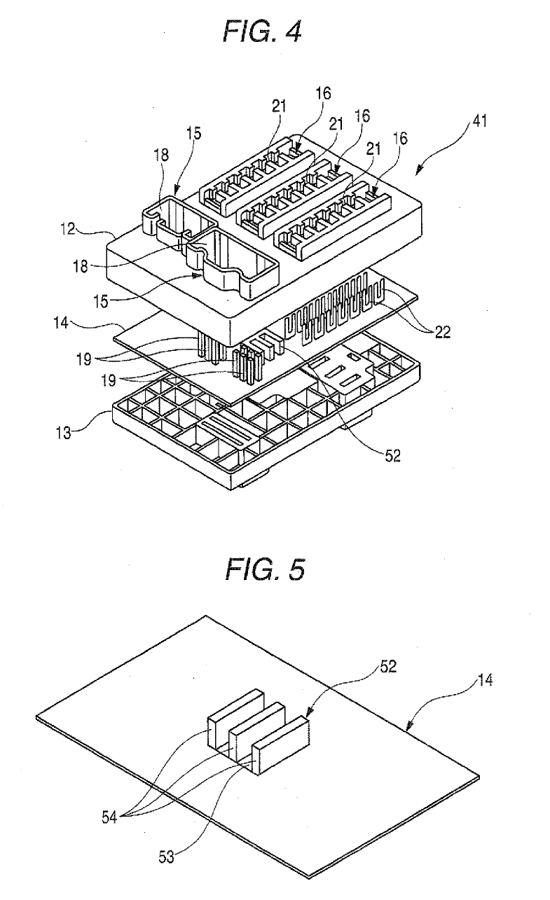

The electrical connection box regarding to the second embodiment will be described in detail with reference to FIGS. 4 to 6. The like reference numerals can be denoted to the like component and structure as in the first embodiment and the description thereof will be omitted.

As shown in FIG. 4, the electrical connection box 41 has a plurality of sockets 15. The terminal of the connector is electrically connected to the connection terminal 19 of the circuit substrate 14 disposed within the engaging concave portion 18, by engaging the connector of the wiring harness with the engaging concave portion 18 of the plurality of sockets 15.

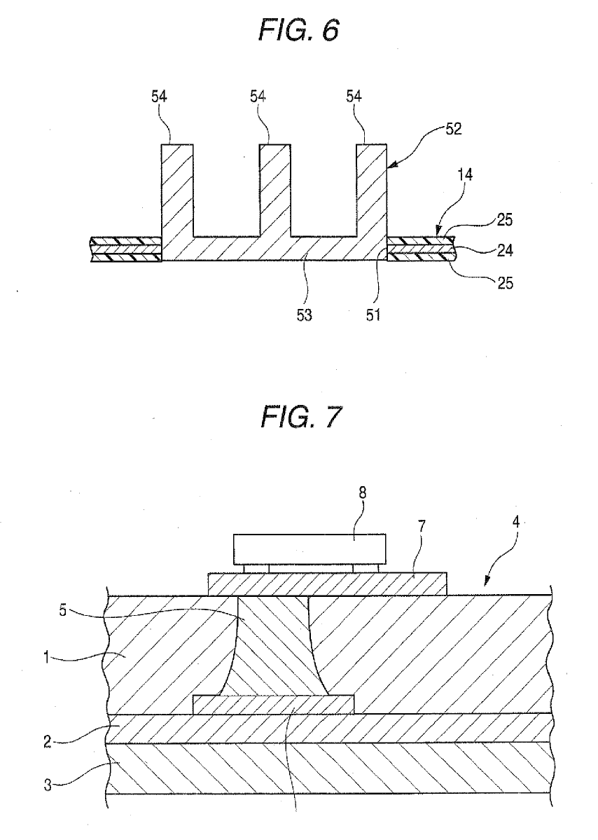

In the electrical connection box 41, as shown in FIGS. 5 and 6, a rectangular hole 51 is formed in the circuit substrate 14, and a block-shaped heat radiation member 52 is press-fitted and then fixed thereto.

The heat radiation member 52 has a structure that a plurality of disk-like fins 54 are arranged on the plate-shaped fixing plate portion 53 with intervals (spaces), and is integrally formed of a metallic material having superior heat conductivity, such as copper or aluminum. The plurality of fins 54 are extended in a direction perpendicular to the circuit substrate 14 from the fixing plate portion 53.

By press-fitting the heat radiation member 52 to the hole 51 of the circuit substrate 14, the metal core 24 of the circuit substrate 14 is connected to the circumference of the heat radiation member 52.

In view of above, according to the electrical connection box 41 regarding to the second embodiment, the heat radiation member 52 is press-fitted to the hole 51 of the circuit substrate 14. As a result, since the heat transmitted from the electrical component 20 to the circuit substrate 14 can be effectively radiated from the heat radiation member 52, the reduction in manufacturing cost and the improvement in recycling property can be much accomplished, as compared to the structure in which the metal column is buried in the substrate.

In this embodiment, the metal core substrate is employed as the circuit substrate 14. As a result, since the heat of the electrical component 20 is transmitted to the metal core 24 of the circuit substrate 14, the heat can he effectively radiated from the metal core 24. Additionally, the heat of the electrical component 20 can be transmitted to the heat radiation member 52 via the metal core 24, and then radiated from the heat radiation member 52.

Further, since the plurality of fins 54 are provided to the heat radiation member 52, the heat of the electrical member 20 can be desirably radiated from the fins 54 of the heat radiation member 52.

Alternatively, the invention may be implemented using a combination the first embodiment and the second embodiment. In particular, the electrical component 20 may be directly attached to the heat radiation member 30 and at the same time the heat radiation member 52 may be press-fitted to the hole 51 of the circuit substrate 14.

In this case, since the heat of the electrical component 20 can be effectively radiated from the heat radiation member 30 directly attached to the electrical component 20, and the heat radiation member 52 attached to the circuit substrate 14, more desirable radiation effect can be obtained.

What is claimed is:

1. An electrical connection box, comprising:
a circuit substrate, on which an electrical component is mounted;
a case, adapted to cover the circuit substrate; and
a heat radiation member, directly attached to the electrical component.

2. The electrical connection box according to claim 1, wherein
the circuit substrate comprises a hole passing through both surfaces of the circuit substrate, and
the heat radiation member is press-fitted to the hole.

3. The electrical connection box according to claim 1, wherein
the circuit substrate includes a metal core substrate in which a plate-shaped metal core covered with a insulator.

4. The electrical connection box according to claim 1, wherein
the heat radiation member comprises a plurality of fins.

5. The electrical connection box according to claim 4, wherein
the plurality of fins are extended in a direction parallel to the circuit substrate.

6. The electrical connection box according to claim 4, wherein
the plurality of fins are extended in a direction perpendicular to the circuit substrate.

7. The electrical connection box according to claim 4, wherein
a space is disposed between the adjacent two of the plurality of fins.

8. An electrical connection box, comprising:
a circuit substrate, on which an electrical component is mounted, and which comprises a hole passing through both surfaces of the circuit substrate;
a case, adapted to cover the circuit substrate; and
a heat radiation member, press-fitted to the hole.

9. An electrical connection box, comprising:
a circuit substrate, on which an electrical component is mounted, and which comprises a through hole; and
a heat radiation member, held in contact with the electrical component, wherein
one of the electrical component and the heat radiation member is inserted into the through hole.
